(19) United States
(12) Patent Application Publication
(10) Pub. No.: US 2019/0099049 A1
(43) Pub. Date: Apr. 4, 2019

(54) FOLDED TISSUE PRODUCT

(71) Applicant: Kimberly-Clark Worldwide, Inc., Neenah, WI (US)

(72) Inventors: Jessica Annette Ives Dieringer, Menasha, WI (US); Andrew Peter Bakken, Appleton, WI (US)

(21) Appl. No.: 16/094,586

(22) PCT Filed: Apr. 29, 2016
(86) PCT No.: PCT/US2016/030054

§ 371 Date: Oct. 18, 2018

(51) Int. Cl. A47K 10/42; A47K 10/16

(52) U.S. Cl. CPC A47K 10/42; B31D 1/04; A47K 10/16

(57) ABSTRACT

The invention provides sheet material, such as tissue products, folded such that the first and second ends of the sheet are folded towards one another, but do not abut or overlap. As such the first and second ends are spaced apart from one another such that there is some non-zero distance between them. The space between the two ends defines a waist portion having a height dimension that is less than either of the ends of the folded product. When sheets of material are folded in this manner and stacked one on top of another, the resulting stack also has a middle portion that is slimmer than the end portions. For example, the ends may have a first and second height (H1 and H2) that is substantially similar, while the middle portion may have a third height (H3) that is less than the first and second heights.

### BACKGROUND OF THE DISCLOSURE

Some disposable sheet dispensers have been designed where the dispensing opening is a narrow slot or a slit. Such openings are well-suited to presenting tissue sheets for sequential removal. In some applications, however, it is sometimes difficult to remove the initial sheet from the stack when a narrow opening is present. For instance, the narrow opening can interfere with the ability of the user to grab the leading edge of the first sheet if the leading edge is located in a position that is not adjacent to the opening. Additionally the second sheet in the stack may be selected prior to the first sheet if its leading edge is in the vicinity of the opening resulting in a double sheet pull.

Another factor that is important in sheet dispensing is the height of the sheet that has been dispensed relative to the top surface of the package. Some sheet fold and interfold configurations present an exposed sheet that has an exposed sheet height which is too short which may result in sheet fallback into the package, increase the possibility of sheet tearing, or be too short to properly grasp it for proper dispensing. Alternately some sheet fold and interfold configurations present an exposed sheet that has an exposed sheet height which is too tall which may result in streaming or double pulls or too much of the sheet exposed to the elements. Streaming occurs when the user pulls the top sheet out, and the subsequent sheet or sheets are also withdrawn without the separation of the following sheet or sheets. In addition the appearance of the height of the exposed portion of the pulled sheet is preferred by consumers if it is in the range where it is not too short or too tall.

### SUMMARY OF THE DISCLOSURE

The present invention now provides a novel fold pattern for folding sheet material, such as a tissue product, where the fold patterns results in two ends of the folded product beings spaced apart from one another some non-zero distance. Sheet material folded in this manner may be stacked so as to provide a stack of folded sheet material having improved dispensing. The improved dispensing is attributable, at least in-part, to the stack having a variable height along its length and more particularly a middle portion that is narrower, or has less height, than the end portions.

For example, in one embodiment the present invention provides a stack of folded tissue products comprising a first and a second folded tissue sheet, the first and the second folded tissue sheet each having a first edge terminating at a first vertical axis and a second edge terminating at a second vertical axis wherein the distance between the first and the second vertical axis is greater than zero. In this manner the resulting tissue stack has a first end, a middle and a second end, where the first and the second ends generally have a first and a second end height that is substantially equal and the middle has a third height that is generally less than the height of the first and second ends.

In another embodiment the present invention provides a folded sheet product having a first panel, a second panel and a third panel, the first and second panels connected to one another by a first fold line and the second and third panels connected to one another by a second fold line, a fourth panel and a fifth panel connected to one another by a third fold line, wherein the third fold line is perpendicular to the first and second fold lines, wherein the first panel has a first edge terminating at a first vertical axis and the third panel having a second edge terminating at a second vertical axis, wherein the distance between the first and the second vertical axis is greater than zero.

In still another embodiment the present invention provides a stack of folded tissues comprising a first folded tissue sheet having a first edge terminating at a first vertical axis and a second edge terminating at a second vertical axis, and a second folded tissue sheet having a first edge terminating at the first vertical axis and a second edge terminating at the second vertical axis, wherein the distance between the first and the second vertical axis is greater than zero.

In other embodiments the present invention provides a folded sheet product having been first folded along a first principle axis of the sheet and then at least twice folded along a second axis substantially perpendicular to the first axis resulting in a first panel, a second panel and a third panel, the first and second panels connected to one another by a first fold line and the second and third panels connected to one another by a second fold line, the first panel having a first edge terminating at a first vertical axis and the third panel having a second edge terminating at a second vertical axis, wherein the distance between the first and the second vertical axis is greater than zero.

In yet other embodiments the present invention provides a stack of folded sheet products wherein two or more of the sheet products have been first folded along a first principle axis of the sheet and then at least twice folded along a second axis substantially perpendicular to the first axis resulting in a first panel, a second panel and a third panel, the first and second panels connected to one another by a first fold line and the second and third panels connected to one another by a second fold line, the first panel having a first edge terminating at a first vertical axis and the third panel having a second edge terminating at a second vertical axis, wherein the distance between the first and the second vertical axis is greater than zero.

### BRIEF DESCRIPTION OF DRAWINGS

FIG. 1 is a perspective view of a single folded tissue;

FIG. 2 is a perspective view of a single folded tissue according to one embodiment of the present invention;

FIG. 3 is a perspective view of a single folded tissue according to one embodiment of the present invention

FIG. 4 is a cross-sectional view of a stack of tissues according to one embodiment of the present invention; and

FIG. 5 is a cross-sectional view of a stack of tissues according to one embodiment of the present invention.

### DEFINITIONS

As used herein, the term “sheet material” refers to a fibrous sheet material suitable for forming a tissue product.

As used herein, the term “tissue product” and “tissue sheet” generally refer to products made from sheet material and includes, bath tissues, facial tissues, paper towels, industrial wipers, foodservice wipers, napkins, medical pads, and other similar products. Tissue products may comprise one, two, three or more plies.

As used herein the term “ply” refers to a discrete product element. Individual plies may be arranged in juxtaposition to each other. The term may refer to a plurality of web-like components such as in a multi-ply facial tissue, bath tissue, paper towel, wipe, or napkin.

As used herein the term “panel” refers to a portion of a tissue sheet bounded by a fold line. Typically a single fold line will divide a tissue sheet into two panels.

As used herein the term “Peak Load” refers to the force needed to compress a stack of folded tissue products to 50 percent of their original thickness. Peak load is measured as described in the Test Methods section and typical has units of grams-force (gf).

### DETAILED DESCRIPTION OF THE DISCLOSURE

Generally, the present invention is directed to folded sheet material, such as fibrous webs and more particularly tissue products. Tissue products useful in the present invention may include dry and wet wiping products and may comprise one or more fibrous webs or plies, where multiple plies are arranged in facing arrangement with one another. The tissue products are folded and stacked one on top of another such that the stack has a first end, a second end and a middle portion where the height of the first and second ends is generally greater than the middle. In this manner the tissue fold pattern provides a stack of tissues having a narrow waist that may be useful in packaging and dispensing compact stacks of tissues from flexible dispensers.

In one embodiment, the tissue products are folded such that the first and second ends of the tissue product are folded towards one another, but do not abut or overlap one another. As such, when folded, the first and second ends of the tissue product are spaced apart from one another such that there is some non-zero distance between them. For example, a tissue product may comprise a first fold line along one principle axis of the tissue sheet forming a first panel and a second panel. The sheet may then be further folded by forming second and third fold lines substantially perpendicular to the first fold lines and forming third, fourth and fifth panels. The third panel has a first edge terminating at a first vertical axis and the fifth panel has a second edge terminating at a second vertical axis, wherein the distance between the first and the second vertical axis is greater than zero. In this manner the third and fifth panels are brought into facing arrangement with fourth panel, but leave some portion of the fourth panel that is not contacted by the third or fifth panel. The portion of the fourth panel that is not contacted by the third or fifth panels generally defines a waist portion in the folded product, which has a height dimension that is less than either of the ends of the folded tissue product.

In another embodiment, the tissue product may be folded as described I the above embodiment and then the third or fifth panels may be further folded along a fourth and fifth fold line to produce sixth and seventh panels. The produce sixth and seventh panels may be brought into facing arrangement with the third and fifth panels and the folded edges created by the fourth and fifth fold lines may be spaced apart from one another some non-zero distance. In the present embodiment there remains a portion of the fourth panel that is not contacted by the third or fifth panel that generally defines a waist portion in the folded product, which has a height dimension that is less than either of the ends of the folded tissue product.

When tissue products are folded according to the present invention and stacked one on top of another, the resulting stack also has a middle portion that is slimmer than the end portions. For example, the ends may have a first and second height (H1 and H2) that is substantially similar, while the middle portion may have a third height (H3) that is less than the first and second heights. Forming a stack in this manner provides the stack with a slim, compact appearance, without reducing the number of sheets. Further, in certain embodiments, the middle portion of the stack may be more compressible and more easily grasped by a user and may be orientated with the edge of the tissue sheet to aid in dispensing.

Turning now to FIG. 1, there is shown a single folded tissue product 10 useful in the present invention. The single sheet employed for the tissue product 10 may be single-ply or may be multi-ply. The tissue product 10 may be any type of fibrous web and may comprise any known material for forming absorbent products such as towels, wipes, napkins, and the like. The illustrated product 10 is rectangular having a length and a width. To begin folding, the tissue product 10 is generally folded in half along its width to form a folded edge 50 and yielding a rectangular folded product having a length (l), which is generally greater than the width (w). Other shapes of folded tissue products are contemplated and the invention is not limited to rectangular shaped products. In the illustrated embodiment an individual tissue sheet is folded such that the sheet width is reduced by approximately half while the length is maintained. However, in other embodiments the length may be reduced by approximately half by folding while the width is maintained.

With further reference to FIG. 1, the folded tissue product 10 comprises a top surface 40 and an opposed bottom surface (not shown in FIG. 1). The product 10 further comprises a first panel 42 joined to a second panel 44 along a fold line 50. The first panel 42 is created by folding the sheet along a first fold line 50 across the width of the sheet to create a leading edge 52. When folded across the width of the sheet the first panel 42 is brought into facing arrangement with the top surface 46 of the second panel 44 and extends between the folded edge 50 and the leading edge 52. In this manner the tissue product is folded such that the first 42 and second 44 panels have substantially similar width and length dimensions and the top panel's leading edge 52 is generally aligned with the bottom panel's leading edge 54.

Folding the tissue sheet as illustrated in FIG. 1 results in a V-folded tissue product having a first 42 and second 44 panels with leading edges 52, 54 that aligned. Opposite the leading edges 52, 54 is a single folded edge 50. In a particularly preferred embodiment the sheet is folded such that the first fold, in the illustrated embodiment shown as fold line 50, is parallel to the machine direction of the sheet. In each case when the tissue sheet is folded over onto itself the number of panels of the tissue sheet, and in certain embodiments plies, is effectively increased for purposes of greater strength during dispensing.

While it may be desirable to fold the sheet only once as illustrated in FIG. 1, the invention is not so limited. In certain embodiments the sheet may not be folded before proceeding with the folds described below. In other embodiments the sheet may be subjected to multiple folds across the width of the sheet to create three or more panels. For example, the sheet may be first be C-folded, Z-folded or W-folded across its width prior to folding as described below. In those embodiments where the sheet is first folded across its width multiple times the folds are parallel to one another and more preferably parallel to the machine direction of the sheet.

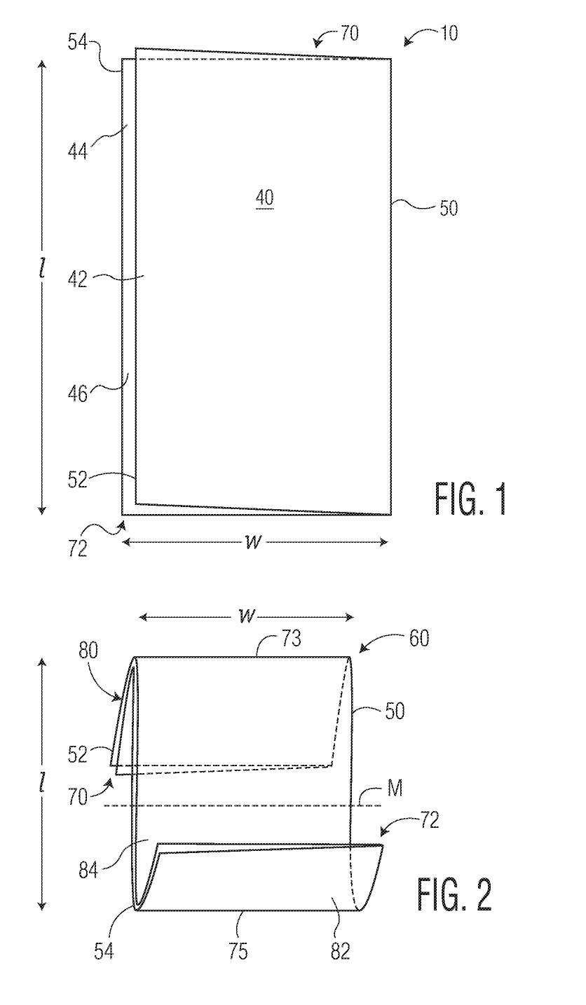

Turning now to FIG. 2, in one particularly preferred embodiment the folded tissue 60 is completed by folding the top edge 70 along a second fold line 73 towards the bottom edge 72. Similarly the bottom edge 72 is folded along a third fold line 75 towards the top edge 70. In this manner upper 80 and lower 82 panels are created and folded over towards the midpoint (M) of the center panel 84. The upper 80 and lower panels 82 may be folded in the same direction to create a C-folded tissue product or folded in opposite directions to form a Z-folded (as illustrated in FIG. 2) tissue product.

As illustrated in FIG. 2, when the tissue product is Z-folded, the upper panel 80 is brought into facing arrangement with the bottom surface of the center panel 84 and the lower panel 82 is brought into facing arrangement with the top surface of the center panel 84. The fold pattern results in second 73 and third 75 fold lines which are generally parallel to one another as are the top 70 and bottom 72 edges.

In the embodiment illustrated in FIG. 2 the width of the folded product 60 is approximately half of the unfolded sheet and the top 70 and bottom 72 edges (also referred to herein as the first leading edge and the second leading edge) are spaced apart from one another some non-zero distance. In a particularly preferred embodiment, the first 70 and the second 72 leading edges are folded towards the midpoint (M) and are spaced equal distance from the midpoint. When folded in this manner the top 80 and bottom 82 panels are substantially similar in size having the same width and substantially similar lengths. One skilled in the art however, will appreciate that the invention is not so limited and that the relative length of the top and bottom panel may vary. For example, in one embodiment the length of the top panel may be greater than the length of the bottom panel. In other embodiments the length of the bottom panel may be greater than the length of the top panel.

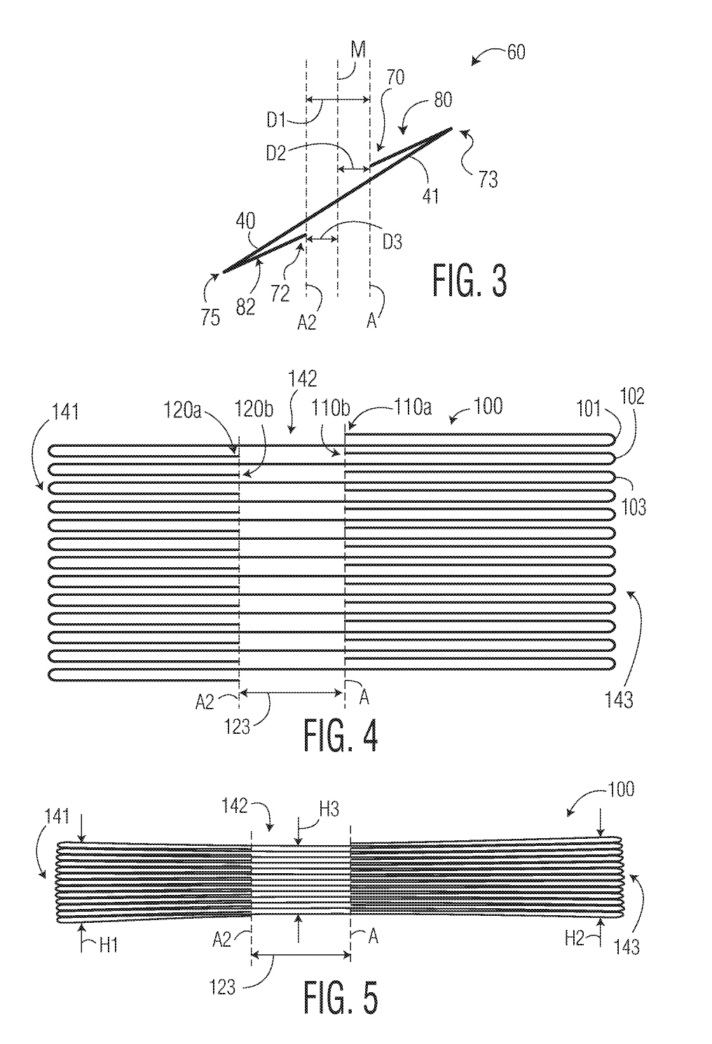

The relative spacing of the first 70 and second 72 leading edges and the relative size of the top 80 and bottom 82 panels is further illustrated in FIG. 3. For example, the top 80 and bottom 82 panels are formed by folding the tissue sheet along fold lines 73 and 75 whereby the top panel 80 is brought into facing arrangement with the top surface 40 of the tissue sheet and the bottom panel 82 is brought into facing arrangement with the bottom surface 41. The edges 70, 72 are folded towards the midpoint (M) of the sheet and with the first edge 70 spaced away from the midpoint (M) a distance D2 and the second edge 72 spaced away a distance D3. In this manner the first 70 and second 72 edges are spaced apart from one another some non-zero distance D1. Thus where the tissue sheet is first V-folded and then Z-folded, the folded tissue product generally comprises two panels of a single sheet at the midpoint, where each panel may comprise multiple plies.

In other embodiments the first and the second edges may be folded towards the midpoint of the tissue sheet with one of the ends crossing the midpoint. In such embodiments, however, there is generally some portion of the tissue product where the first and the second ends are spaced apart from one another.

The distance (D1) between the first 70 and the second 72 ends may generally range from about 0.5 to about 30 percent of the length (l) of the folded tissue product 60, such as from about 5 to about 25 percent and more preferably from about 10 to about 20 percent. For example, where the folded sheet product 60 has a length (l) of about 12 cm, the distance (D1) between the first 70 and the second 72 ends may be some non-zero distance, such as from about 1 to about 30 mm, more preferably from about 5 to about 25 mm and still more preferably from about 10 to about 20 mm.

While the present invention is well suited for use in folding tissue sheets having a wide variety of shapes and sizes, in one embodiment the unfolded sheet has a length of from about 15 to about 30 cm and width from about 15 to about 30 cm. In a particularly preferred embodiment the sheet is rectangular where the width is greater than the length.

In one embodiment, when the tissue sheet is folded as illustrated in FIGS. 1 and 2, the sheet may be folded in half width wise to yield a V-folded tissue having a length of from about 15 to about 30 cm and width from about 7.5 to about 15 cm. The V-folded tissue may then be Z-folded such that it has a length of from about 8 to about 28 cm and width from about 7.5 to about 15 cm. The first end of the Z-folded tissue is folded over such that it creates a panel in facing contact with the top of the folded tissue. The second end of the Z-folded tissue is folded over such that it creates a panel in facing contact with the bottom of the folded tissue. The opposed first and second ends of the Z-folded tissue are spaced apart from one another some non-zero distance, such as from about 1 to about 30 mm, more preferably from about 5 to about 25 mm and still more preferably from about 10 to about 20 mm.

For storage and dispensing single tissue sheets may be stacked together to form a stack of tissues. A stack may comprise any number of tissues. For example, in certain embodiments the stack may comprise from about 5 to about 100 individual tissue products and more preferably from about 10 to about 50 tissue products and still more preferably from about 15 to about 40 tissue products. When referenced herein, the upper most tissue product in a stack is generally referred to as the nth tissue, while the subsequent abutting tissue in the stack is referred to as the n+1 tissue and so on.

Preferably all of the tissue products within a stack are folded. In certain preferred embodiments all of the sheets within a stack are folded in the same fold configuration. In other embodiments, the stack may comprise Z-folded tissues as well as tissues folded in another configuration, such as C-folded, V-folded or W-folded. For example, in one embodiment the nth through n+10 tissues are Z-folded tissues and the n+11 through n+25 are folded in a different manner than the nth through n+10 tissues. While individual tissue products or even significant portions of the stack may be folded differently for improved dispensing, or to create a starter sheet(s), or for another purpose, in a particularly preferred embodiment at least the nth and n+1 tissues in a stack are Z-folded as described herein.

In a particularly preferred embodiment, such as that illustrated in FIG. 4, the folded tissue sheets 101, 102, 103 are not interleaved with one another when stacked together to form a stack of tissues 100. In such embodiments adjacent sheets do not overlap one another. When tissue sheets are folded and stacked in the foregoing configuration the user removes the upper most tissue sheet from the stack and the subsequent sheet is exposed, but does not become separated from the stack.

As further illustrated in FIG. 4, in one preferred embodiment, the nth and n+1 tissues are Z-folded in a similar fashion. That is, for any two folded tissues 101, 102 the first leading edges 110a, 110b terminate at a first vertical axis A and the second leading edges 120a, 120b terminate at a second vertical axis A2 where there is a distance 123 between A and A2, referred to herein as an edge gap.

Accordingly, in a particularly preferred embodiment, such as that illustrated in FIG. 4, the first leading edge of each folded tissue in the stack terminates at the first vertical axis (A) and the second leading edge of each folded tissue in the stack terminates at the second vertical axis (A2). In this manner the stack 100 may generally be defined as having three distinct areas, a first folded end 141, a middle portion 142 and a second folded end 143.

Although the edge gap 123 is illustrated in FIG. 4 as being substantially equal throughout the stack 100, the invention is not so limited. For example, the edge gap may vary between the two upper most tissues in a stack compared to the bottom two tissues. In other embodiments the upper most tissues in a stack, such as the nth through n+10 tissues may have a first edge gap, while the bottom most tissues in the stack, such as the n+11 through n+24 tissues may have an edge gap that is greater or less than the first edge gap.

While not wishing to be bound by theory, folding tissue sheets in this manner improves dispensing and provides a stack 100 with first and second folded ends 141, 143 comprising the same number of panels and having a first height H1 and a second height H2 that are substantially similar, as illustrated in FIG. 5. By folding the sheets such that there is an edge gap 123, however, the middle portion 142 comprises a different number of sheets than the first and second folded ends 141, 143 and having a height H3 that is less than H1 and H2. In this manner the stack of folded tissues may be said to have a narrower waist, generally defined by the middle portion of the stack.

Thus, in one particularly preferred embodiment, the invention provides a stack of tissues having a first end having a first height H1, generally measured about 1 cm from the first end of the tissue stack, a second end having a second height H2, generally measured about 1 cm from the second end of the tissue stack opposite of the first end, and a middle having a third height H3, generally measured at the midpoint of the tissue stack, where H1, H2 are substantially equal and where H3 is about 10 percent less than H1 and H2, such as from about 10 to about 50 percent less.

One skilled in the art will appreciate that stack height is the vertical measurement, taken from a horizontal reference plane, of the plurality of tissues sheets as it lays unrestrained on the horizontal reference surface. It is to be recognized that the same size and number of tissues comprising the plurality may have different heights depending upon the folding pattern, the caliper of the tissues, interleaved pattern, etc., used to place one tissue in proximity to the next tissue in the plurality. In those embodiments where H1 and H2 are substantially equal there may be slight variations in the heights, such as less than about 5 percent and more preferably less than about 2 percent.

Not only does the instant fold pattern result in a sack of tissues having differing heights at its two ends compared to its middle, the force required to compress the stack may also varying between the ends and the middle. In one embodiment the stack of the present invention has a first end, a middle and second end, where the Peak Load of the middle is less than either the first or the second ends. In a particularly preferred embodiment the difference (Delta Peak Load) between average Peak Load of the first and second ends and the middle Peak Load is greater than 25 percent and more preferably greater than about 30 percent, still more preferably greater than about 40 percent and even more preferably greater than about 50 percent, such as from about 25 to about 80 percent and still more preferably from about 40 to about 70 percent.

Stacks of interfolded tissues are generally stored and dispensed from a dispenser. Suitable dispensers are well known in the art and may include both flexible and rigid dispensers. The tissue stack disclosed herein is particularly well suited for dispensing from flexible dispensers and more particularly small flexible dispensers having a generally rectangular shape with a length less than about 25 cm, such as from about 10 to about 25 cm and a width less than about 15 cm, such as from about 10 to about 15 cm. Flexible dispensers may comprise polypropylene, nylon or other flexible polymeric material.

Regardless of its construction, the dispenser comprises a dispensing orifice and in certain embodiments may comprise a lid covering the dispensing orifice. The lid may be disposable or may be resealable. The dispensing orifice through which the enclosed tissues are dispensed from the carton can have a variety of forms and dimensions. For example, the orifice shape may be round, square, ovoid, triangular or rectangular. In other embodiments the orifice may be a simple slit having a relatively small width relative to its length. Regardless of the specific shape of the orifice, the orifice will generally have a length and a width. The length is the maximum dimension of the dispensing orifice in a direction that is substantially parallel to the leading edge of a tissue to be dispensed. The width of the orifice is the maximum dimension of the orifice in a direction orthogonal to the length of the orifice.

The dispenser generally may be made from any suitable material and may be either rigid or flexible. Particularly preferred dispensers are those formed from flexible materials. For example, in one embodiment, the dispenser may comprise a flexible packet produced from a continuous wall of film which is formed into discrete packets having fine seals along the center bottom of the packet and end seals. The seals can be effected either sonically or thermally as desired. Suitable materials for forming flexible dispensers are well known in the art and include polypropylene, polyethylene, PVA, EVA and nylon. As used herein the term “flexible” it is meant that the film out of which the dispenser is constructed will offer minimal resistance to bending and will tend to conform or deform in the presence of externally applied forces.

Regardless of the construction of the dispenser or particularly the orifice, it the preferred embodiment it may be desirable for the leading edge of the sheet to be disposed near the vertical axis defining the midpoint of the orifice's width. In this manner the leading edge is not so far removed from the orifice's central vertical axis so as to be out of reach of a user in use.

### Test Methods

Compressibility of a stack of tissues across its length was measured by compressing a packaged stack of tissues using a MTS Criterion 43 constant-rate-of-extension tensile frame (MTS Systems Corporation, Eden Prairie, Minn.) with a ½ inch diameter upper platen and a 6 inch diameter lower platen. Three measurements were taken for each sample, in the top, center and bottom of the package. To determine the area of the package to be measured, the edge of the stack of tissues within the package was determined and the width and lengths were measured to determine the midpoint of the stack. Once the midpoint of the stack was determined the top and bottom positions were located half way between the edge of the tissue stack and the midpoint. For packages with a lid the midpoint measurement was taken at the midpoint of tissue stack length and halfway between the edge of the lid and the upper edge of the tissue stack.

To measure compressibility the top, bottom, or middle of the sample is aligned under the upper platen. The upper platen is positioned approximately ½ inch above the sample and then lowered at a rate of 10 mm/min until a preload of 5 grams-force (Initial Thickness) is applied. The upper platen continues to travel at a rate of 20 mm/min and compresses the sample to 50 percent of the initial thickness. The following results are then reported and recorded: Initial Thickness at 5 grams-force (mm) and Peak Load at 50 percent thickness (grams-force). For each sample and each location—middle, bottom and top—five measurements are taken and the average is recorded. Results are reported as Peak Load at 50 percent thickness or Peak Load, having units of grams-force (gf).

### Examples

To illustrate the benefits of the inventive folded tissue products, particularly the benefits of forming a stack of tissues having a narrow waist, several inventive stacks of tissue products were prepared and compared to commercially available products. The inventive samples were prepared by folding a 3-ply tissue product having dimensions of 20.8 cm×21.3 cm. The tissue products were first V-folded in half width wise and then Z-folded length wise whereby there was a gap between the first and second ends of the tissue. Details regarding the fold pattern are provided in Table 1, below. The folded tissues were then stacked on top of one another without interfolding and then packaged in a flexible dispenser, the details of which are provided in Table 1, below.

TABLE 1

| | Distance between | | | | |
|---|---|---|---|---|---|
| | first and second | Flexible | Rigid | Package | |
| | folded tissue | Package | Package | Dimensions | Sheet |
| Sample | ends (mm) | Material | Lid | (L × W × H mm) | Count |
| Code 11 | 20 | Yes | Yes | 160 × 130 × 30 | 30 |
| Code 12 | 20 | Yes | Yes | 160 × 130 × 30 | 30 |
| Code 14 | 20 | Yes | Yes | 160 × 130 × 30 | 30 |
| HUGGIES ® wipes soft pack | 0 | Yes | No | 270 × 100 × 50 | 56 |
| HUGGIES ® Clutch ‘N’ | 0 | Yes | Yes | 231 × 147 × 38 | 32 |
| Clean ® wipes | | | | | |
| PUFFS ® softpack | 0 | Yes | No | 223 × 114 × 81 | 132 |
| KLEENEX ® wallet pack | 0 | Yes | No | 120 × 80 × 100 | 10 |

The samples above were subjected to compressibility testing as described in the Test Methods section above. The results of the compressibility testing are reported in the table below. The delta peak load is the percent difference in peak load between an average of the top and bottom peak load and the middle peak load.

TABLE 2

| | | | | Top and | |
|---|---|---|---|---|---|
| | Peak | Peak | Peak | Bottom | Delta |
| | Load | Load | Load | Average | Peak |
| | Top | Middle | Bottom | Peak Load | Load |
| Sample | (gf) | (gf) | (gf) | (gf) | (%) |
| Code 11 | 4186 | 1670 | 5451 | 4819 | 65 |
| Code 12 | 3853 | 1732 | 3634 | 3744 | 54 |
| Code 14 | 1977 | 933 | 2034 | 2006 | 53 |
| HUGGIES ® wipes | 8102 | 7138 | 6835 | 7469 | 4 |
| soft pack | | | | | |
| HUGGIES ® Clutch | 4950 | 3596 | 4396 | 4673 | 23 |
| ‘N’ Clean ® wipes | | | | | |
| PUFFS ® softpack | 2554 | 4247 | 3644 | 3099 | 137 |
| KLEENEX ® | 2554 | 3630 | 2956 | 2755 | 132 |
| wallet pack | | | | | |

While various folded, stacked and packaged tissue products have been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the following embodiments:

In a first embodiment the present invention provides a folded sheet product having a first panel, a second panel and a third panel, the first and second panels connected to one another by a first fold line and the second and third panels connected to one another by a second fold line, the first panel having a first edge terminating at a first vertical axis and the third panel having a second edge terminating at a second vertical axis, wherein the distance between the first and the second vertical axis is greater than zero.

In a second embodiment the present invention provides the product of the first embodiment wherein the sheet product is C-folded or Z-folded.

In a third embodiment the present invention provides the product of the first or the second embodiments further comprising a fourth panel and a fifth panel connected to one another by a third fold line, wherein the third fold line is perpendicular to the first and second fold lines.

In a fourth embodiment the present invention provides the product of any one of the first through third embodiments wherein the folded sheet product has a width dimension and a length dimension and wherein the distance between the first and the second vertical axis is from about 0.5 to about 30 percent of the length dimension.

In a fifth embodiment the present invention provides the stack of any one of the first through the fifth embodiments wherein the distance between the first and the second vertical axis is from about 1 to about 30 mm and more preferably from about 5 to about 20 mm.

In a sixth embodiment the present invention provides the stack of any one of the first through the fifth embodiments wherein the first trailing edge terminates at the first vertical axis and the second trailing edge terminates at the second vertical axis.

In a seventh embodiment the present invention provides a stack of tissue products wherein the stack comprises two or more folded tissue products of any one of the first through sixth embodiments.

In an eighth embodiment the present invention provides the stack of the seventh embodiment wherein the tissue products are not interfolded.

In a ninth embodiment the present invention provides the stack of the seventh or eighth embodiments wherein all of the tissue products in the stack are folded in a substantially similar manner and all of the tissue products have been V-folded and Z-folded.

In a tenth embodiment the present invention provides the stack of any one of the seventh through the ninth embodiments wherein the stack has a first end, a middle and a second end and wherein the height of the first and the second ends is greater than the height of the middle.

In an eleventh embodiment the present invention provides the stack of the tenth embodiment wherein the first and the second end is substantially similar.

In a twelfth embodiment the present invention provides the stack of the tenth embodiment wherein the middle is at least about 10 percent less than the height of the first or the second ends.

In a thirteenth embodiment the present invention provides the stack of anyone of the seventh through the ninth embodiments having a first end, a middle and a second end and the wherein the Peak Load of the first end or the second end is greater than the Peak Load of the middle.

In a fourteenth embodiment the present invention provides the stack of the thirteenth embodiment wherein the Peak Load of the middle is at least about 40 percent less than the Peak Load of the first end or the second end.

What is claimed is:

1. A folded sheet product having a first panel, a second panel and a third panel, the first and second panels connected to one another by a first fold line and the second and third panels connected to one another by a second fold line, a fourth panel and a fifth panel connected to one another by a third fold line, wherein the third fold line is perpendicular to the first and second fold lines, wherein the first panel has a first edge terminating at a first vertical axis and the third panel having a second edge terminating at a second vertical axis, wherein the distance between the first and the second vertical axis is greater than zero.

2. The folded sheet product of claim 1 wherein the sheet product is first V-folded and then C-folded or Z-folded.

3. The folded sheet product of claim 1 wherein the sheet is first C-folded and then C-folded or Z-folded.

4. The folded sheet product of claim 1 wherein the folded sheet product has a width dimension and a length dimension and wherein the distance between the first and the second vertical axis is from about 0.5 to about 30 percent of the length dimension.

5. The folded sheet product of claim 1 wherein the distance between the first and the second vertical axis is from about 1 to about 30 mm.

6. The folded sheet product of claim 1 wherein the distance between the first and the second vertical axis is from about 5 to about 20 mm.

7. A stack of folded sheet products wherein two or more of the sheet products have a first panel, a second panel and a third panel, the first and second panels connected to one another by a first fold line and the second and third panels connected to one another by a second fold line, a fourth panel and a fifth panel connected to one another by a third fold line, wherein the third fold line is perpendicular to the first and second fold lines, wherein the first panel has a first edge terminating at a first vertical axis and the third panel having a second edge terminating at a second vertical axis, wherein the distance between the first and the second vertical axis is greater than zero.

8. The stack of claim 7 wherein the two or more sheet products are C-folded or Z-folded.

9. The stack of claim 7 wherein the two or more sheet products are first V-folded and then C-folded or Z-folded.

10. The stack of claim 7 wherein the two or more sheet products have a width dimension and a length dimension and wherein the distance between the first and the second vertical axis is from about 0.5 to about 30 percent of the length dimension.

11. The stack of claim 7 wherein the distance between the first and the second vertical axis is from about 1 to about 30 mm.

12. The stack of claim 7 wherein the distance between the first and the second vertical axis is from about 5 to about 20 mm.

13. The stack of claim 7 wherein the stack has a first end, a middle and a second end and wherein the height of the first and the second ends is greater than the height of the middle.

14. The stack of claim 13 wherein the height of the first and the second end is substantially similar.

15. The stack of claim 13 wherein the height of the middle is at least about 10 percent less than the height of the first or the second ends.

16. The stack of claim 7 wherein the stack has a first end, a middle and a second end and wherein the Peak Load of the first end or the second end is greater than the Peak Load of the middle.

17. The stack of claim 16 wherein the stack has a first end, a middle and a second end and wherein the Peak Load of the middle is at least about 40 percent less than the Peak Load of the first end or the second end.

18. A tissue sheet dispenser comprising a flexible tissue dispenser having a plurality of walls defining an interior space and a stack of folded sheet products disposed within the interior space, the stack comprising at least two sheet products having a first panel, a second panel and a third panel, the first and second panels connected to one another by a first fold line and the second and third panels connected to one another by a second fold line, a fourth panel and a fifth panel connected to one another by a third fold line, wherein the third fold line is perpendicular to the first and second fold lines, wherein the first panel has a first edge terminating at a first vertical axis and the third panel having a second edge terminating at a second vertical axis, wherein the distance between the first and the second vertical axis is greater than zero.

19. The tissue sheet dispenser of claim 18 wherein the stack of folded sheet products has a first end, a middle and a second end and wherein the height of the first end and the second end is substantially equal and the height of the first end and the second end are greater than the height of the middle.

20. The tissue sheet dispenser of claim 18 wherein the stack of folded sheet products has a first end, a middle and a second end and the wherein the Peak Load of the middle is at least about 40 percent less than the Peak Load of the first end or the second end.
